(19) United States
(12) Patent Application Publication
(10) Pub. No.: US 2023/0081277 A1
(43) Pub. Date: Mar. 16, 2023

(54) METHODS FOR EFFICIENTLY DETERMINING DENSITY AND SPATIAL RELATIONSHIP OF MULTIPLE CELL TYPES IN REGIONS OF TISSUE

(71) Applicant: Ventana Medical Systems, Inc., Tuscon, AZ (US)

(72) Inventors: Xingwei Wang, Tuscon, AZ (US); Mehrnoush Khojasteh, Tuscon, AZ (US); Yao Nie, Tuscon, AZ (US); Jim F. Martin, Tucson, AZ (US); Wenjun Zhang, Tuscon, AZ (US)

(73) Assignee: Ventana Medical Systems, Inc., Tuscon, AZ (US)

(21) Appl. No.: 17/917,072

(22) PCT Filed: Apr. 22, 2021
(86) PCT No.: PCT/US2021/028577

§ 371 Date: Oct. 5, 2022

Related U.S. Application Data
(60) Provisional application No. 63/016,004, filed on Apr. 27, 2020.

(51) Int. Cl. G06V 20/69; G06V 10/25

(52) U.S. Cl. CPC G06F 18/20; G06V 10/25; G06V 20/698; G06V 2201/03

(57) ABSTRACT

Efficient methods for identifying biomarkers are described. The method may include identifying a tumor area. The method may further include identifying a plurality of regions. The method may also include defining, for each region, a bounding area for the region that encompasses the region. The method may include determining, for each region of a first subset of the plurality of regions, that the region is to be ascribed to the tumor, where the bounding area is fully within the tumor area. The method may further include determining, for each region of a second subset of the plurality of regions, whether to ascribe the region to the tumor based on an intersection of the region and the tumor area. The method may also include accessing a metric characterizing a biological observation and generating a result based on the metrics. The result may be used as a biomarker.

### CROSS-REFERENCES TO RELATED APPLICATION

This application claims the benefit of priority to U.S. Application No. 63/016,004, filed Apr. 27, 2020, the entire contents of which are incorporated herein by reference for all purposes.

### BACKGROUND

Immunohistochemistry (IHC) slide image analysis may involve computational analysis. For example, Multiplexed Immunofluorescence (MIF) staining of tissue sections allows simultaneous detection of multiple biomarkers and their co-expression at single-cell level. MIF enables characterization of the immune context in the tumor microenvironment, which has significant influence on response to immunotherapies. The primary analysis may detect and classify all different types of markers/cell phenotypes. After the initial analysis, the second analysis is a very important step for generating different features, such as density or spatial relationship, to correlate clinical studies or trials to predict prognosis or drug performance. Methods and systems to efficiently generate useful results of secondary analysis are desired. These and other improvements are addressed by embodiments described herein.

### BRIEF SUMMARY

Embodiments of the present invention allow for efficiently determining density and spatial relationship features for multiple cell types in regions of tissue. Efficiencies are possible as a result of one or more aspects. The same high magnification used for the image is used for analyzing features (e.g., cell, phenotype, epitumor) in a region of interest (e.g., tumor), avoiding computations to adjust for different magnifications. A feature shape may be complex and describable by a large set of pixel coordinates (e.g., corresponding to each point along a perimeter of the feature or a point at the center of a feature). Performing spatial assessments using the set of pixel coordinates (e.g., to determine whether the feature is within a given region of interest, such as a tumor region) may then involve a large number of computations. To improve computational efficiency, a bounding area having a simpler shape (e.g., a box) can be defined as an area surrounding a feature. The bounding area speeds analysis of whether the feature is within the tumor or another specific region of interest. For example, it may be determined that the feature is sufficiently within a region of interest if the four vertices of a bounding box are all within the region. Hash tables may be used to identify relationships between polygons representing features in a region of interest, tissues, and tumors. Furthermore, parameters for secondary analysis are identified as biomarkers, which may help characterize a tumor or other region of interest.

Embodiments may include a method of identifying a biomarker for a tumor using an image of a biological sample. The method may include identifying a tumor area within the image. The tumor area may depict a boundary of the tumor. The method may further include identifying a plurality of regions of the image. Each region of the plurality of regions corresponds to a tissue block or a biological object (e.g., peritumor, stroma, cell phenotypes, etc.). The method may also include defining, for each region of the plurality of regions, a bounding area (e.g., a bounding box or bounding ellipse) for the region that encompasses the region, where the bounding area includes a polygon or an ellipse. The method may include determining, for each region of a first subset of the plurality of regions, that the region is to be ascribed to the tumor, where the bounding area for each region of the first subset is fully within the tumor area. In addition, the method may include determining, for each region of a second subset of the plurality of regions, that the bounding area for the region is partly within the tumor area. The method may further include determining, for each region of the second subset of the plurality of regions, whether to ascribe the region to the tumor based on an intersection of the region and the tumor area. The method may also include accessing, for each region ascribed to the tumor, a metric characterizing a biological observation. The method may include generating a value of a result based on the accessed metrics. The method may also include comparing the value of the result to a reference value determined by using regions ascribed to another tumor or determined by using regions ascribed to wholly outside the tumor area. Additionally, the method may include determining whether the result is a biomarker based on the comparison

Embodiments may include a method of analyzing an image of a biological sample. The method may include determining a first count or a first density of cell phenotypes within a first region of interest (e.g., tumor). The method may also include determining a second count or a second density of cell phenotypes within a second region of interest (e.g., stroma). The second region of interest may be within the first region of interest. The method may further include generating an output. The output may include the first count or the first density, and the second count or the second density.

Embodiments may include a method of analyzing an image of a biological sample. The method may include identifying a plurality of first cells in a tumor. Each first cell of the plurality of first cells may have a first phenotype. The method may also include identifying a plurality of second cells in the tumor. Each second cell of the plurality of second cells may have a second phenotype. The method may further include calculating, for each first cell of the plurality of first cells, the shortest distance to a second cell of the plurality of second cells using a nearest neighbor search. Additionally, the method may include generating a result based on the calculated shortest distances.

Embodiments may include a method of analyzing an image of a biological sample. The method may include identifying a plurality of first cells in a tumor. Each first cell of the plurality of first cells may have a first phenotype. The method may also include identifying one or more regions in the tumor, where each region of the one or more regions corresponds to a tissue block or a biological object (e.g., peritumor, stroma, etc.). The method may further include calculating, for each first cell of the plurality of first cells, a shortest distance between the first cell and each region of the one or more regions using a nearest neighbor search. In addition, the method may include generating a result based on the calculated shortest distances.

Embodiments may include a method of analyzing an image of a biological sample. The method may include identifying a plurality of regions in a tumor, where each region of the plurality of regions corresponds to a tissue block or a biological object (e.g., peritumor, stroma, etc.). The method may also include determining, for each region of the plurality of regions, a compression level. The method may further include generating a result based on the compression levels.

A better understanding of the nature and advantages of embodiments of the present invention may be gained with reference to the following detailed description and the accompanying drawings.

### BRIEF DESCRIPTION OF THE DRAWINGS

FIG. 1A and 1B show analysis of a MIF image of a tissue.

FIG. 1C shows a comparison of computation time between using high magnification and low magnification according to embodiments of the present invention.

FIG. 2 shows a method of analyzing an image of a biological sample according to embodiments of the present invention.

FIG. 3A shows a flowchart for analyzing an image of a biological sample according to embodiments of the present invention.

FIG. 4 illustrates analyzed areas of an image according to embodiments of the present invention.

FIG. 5A shows example images of tumor tissue according to embodiments of the present invention.

FIG. 5B graphs results of analysis of cell types in tumor tissues according to embodiments of the present invention.

FIG. 6 graphs results of analysis of cell types in tumor tissues according to embodiments of the present invention.

FIG. 7 shows a method of analyzing an image of a biological sample for density or count of cell phenotypes according to embodiments of the present invention.

FIG. 8A illustrates analysis for count or density of a single cell phenotype according to embodiments of the present invention.

FIG. 8B shows results of counting cell phenotypes according to embodiments of the present invention.

FIG. 9 shows a method of analyzing an image of a biological sample for phenotype distances according to embodiments of the present invention.

FIG. 10 shows a computation of distance according to embodiments of the present invention.

FIG. 11 shows multiple phenotypes in a tumor according to embodiments of the present invention.

FIG. 12 shows distances between different phenotypes according to embodiments of the present invention.

FIG. 13 shows a table of results for distances between phenotypes according to embodiments of the present invention.

FIG. 14 shows contours of an epitumor and cells according to embodiments of the present invention.

FIG. 15A shows an image of a biological sample according to embodiments of the present invention.

FIG. 15B shows a zoomed-in image with a red circle annotating the tumor region according to embodiments of the present invention.

FIG. 15C shows an image including blue polygons representing epitumors and black circles representing cells of a phenotype according to embodiments of the present invention.

FIG. 16 shows the selection of a single epitumor polygon within a tumor according to embodiments of the present invention.

FIG. 17 shows the single epitumor surrounded by five contours according to embodiments of the present invention.

FIG. 18 shows a table with results of the distances from cells to epitumor according to embodiments of the present invention.

FIG. 19 shows a method of analyzing an image of a biological sample for distances from cells to regions according to embodiments of the present invention.

FIG. 20 shows method of analyzing an image of a biological sample for compression level according to embodiments of the present invention.

FIG. 21 shows a tumor with regions of different compression levels according to embodiments of the present invention.

FIG. 22 shows different compression levels highlighted by polygons according to embodiments of the present invention.

FIG. 23 shows a list of results for compression levels according to embodiments of the present invention.

FIG. 24 shows a computer system according to embodiments of the present invention.

### DETAILED DESCRIPTION

Certain characteristics of an image of a tissue section, such as density and spatial relationships, may provide useful and important clinical information. These characteristics may be used to understand the clinical status of a subject, including for diagnosis and for monitoring treatment.

A low magnification mask based secondary analysis may be used to conduct secondary analysis of an image to determine characteristics such as density and spatial relationships. However, using a low magnification mask may be computationally intensive.

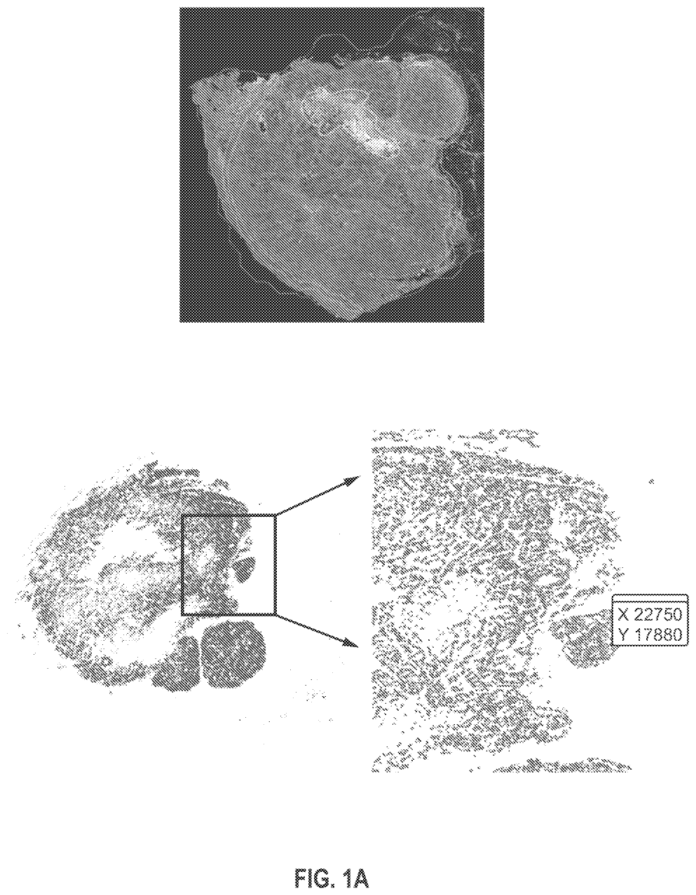

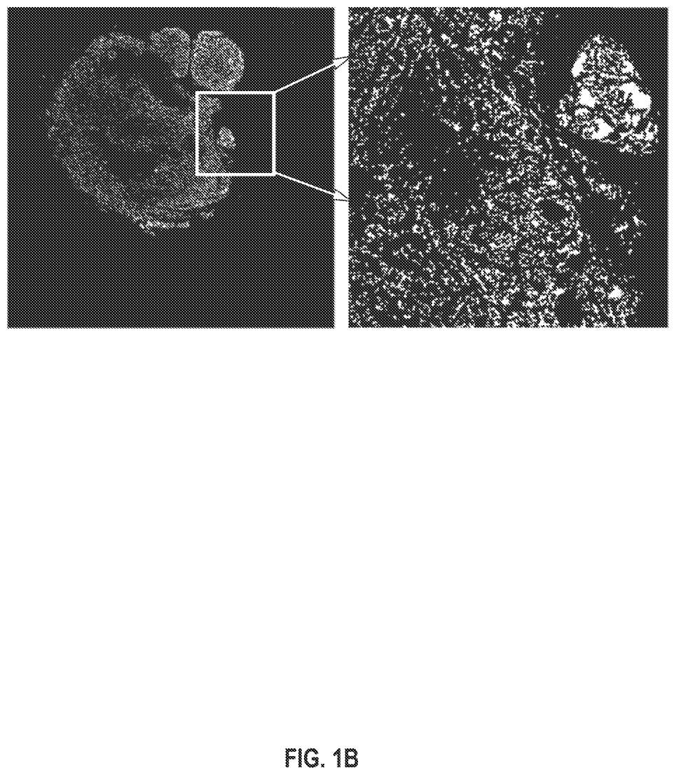

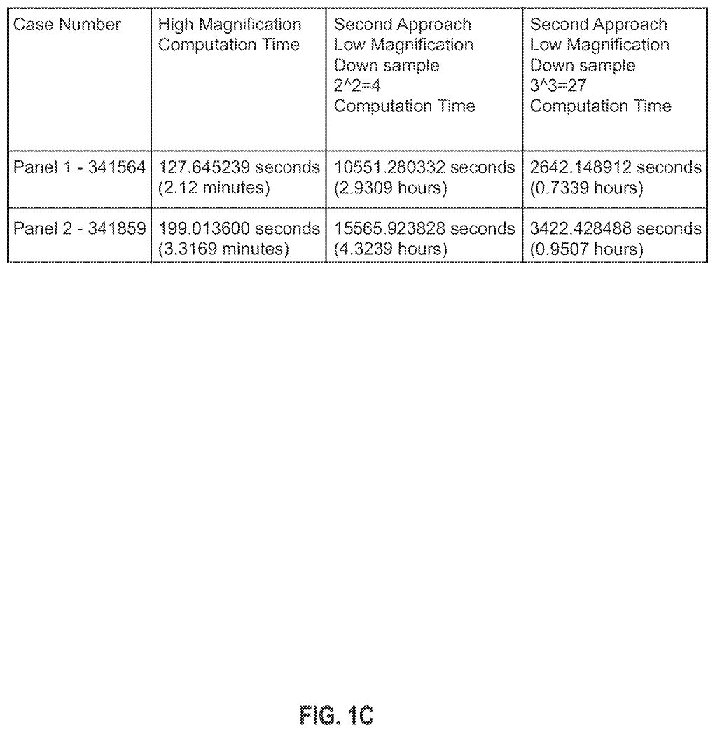

FIG. 1A and FIG. 1B show analysis of a MIF image of a tissue. Both figures show a zoomed-in section displayed in the blue rectangle area. A low magnification mask using the computed polygons is generated.

FIG. 1C shows a table comparing computation times using a high magnification polygon approached method with a low magnification mask based method. The computation time with a high magnification polygon-based method is much faster compared to a low magnification mask based approach according to embodiments of the present invention. Two down-sampling factors have been implemented by using the low magnification mask-based method and the performances are shown in FIG. 1C. One has the low magnification down sampling the original MIF image by a factor of 4. The other has low magnification down sampling by a factor of 27. For example, in a particular panel, computation time using the high magnification polygon-based approach is completed only in only around 3 minutes; while the slowest, the low magnification mask approach by down sample of 4 is completed in 4.32 hours (260 minutes), over 88 times longer. In addition, the high magnification polygon-based analysis generated accurate.

### I. Bounding Areas

Accurate and computationally efficient results may be achieved in embodiments of the present invention. The use of a bounding area, such as a box, to surround polygons helps speed analysis.

### A. Methods of Identifying Biomarkers

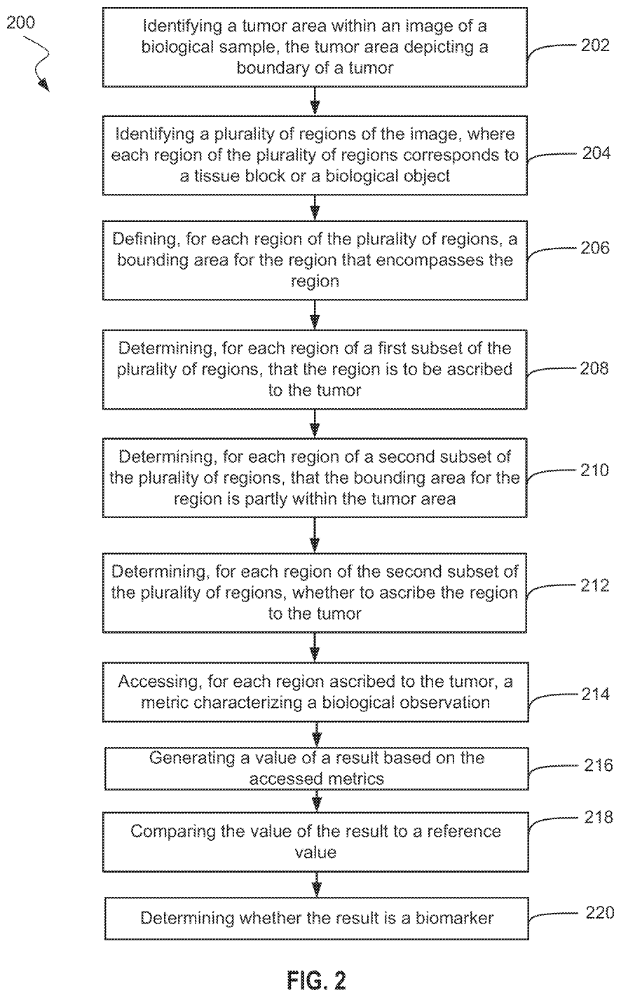

FIG. 2 shows a method 200 of analyzing an image of a biological sample to identify a biomarker for tumors. In some embodiments, method 200 may include capturing the image of the biological sample. Images may be from a variety of immunohistochemistry (IHC) slide images, which may include a single slide or two or more adjacent slides, each with a different biomarker or cell phenotype. The image may be a multiplexed immunofluorescence (MIF) stained image of a tissue section. The biological sample may be a single tissue. In some instances, multiple biological samples may be imaged. For example, images from multiple biopsies, multiple tissue blocks, or a tissue microarray may be used for analysis.

At block 202, a tumor area within the image may be identified. The tumor area may depict a boundary of a tumor. In some embodiments, an area corresponding to a biological structure other than a tumor may be used. Other biological structures may include tumor, stroma, epitumor, or peritumor. The tumor area may be identified manually or by a computer program.

At block 204, a plurality of regions of the image may be identified. Each region of the plurality of regions may correspond to a tissue block or a biological object. The tissue block or biological object may be stroma, epitumor, peritumor, vessel (e.g., blood), a cell phenotype, tumor, necrosis, tissue fold, staining artifact, or red blood cells. The tissue block or biological object may be identified manually or by a computer program. The plurality of regions may cover the entire tumor area and/or the entire image.

At block 206, a bounding area for the region may be defined for each region of a plurality of regions. The bounding area may encompass the region. In some embodiments, the bounding area may circumscribe the region such that at least one point of the region contacts an edge of the bounding area. The bounding area may have an area that within 10%, 20%, 30%, 40%, 50%, 60%, 70%, 80%, 90%, or 100% larger than the region. The bounding area may include a polygon or an ellipse. For example, the bounding area may be a bounding box or bounding circle. The bounding area may include a triangle, a rectangle, a pentagon, a hexagon, a heptagon, an octagon, a nonagon, a decagon, or a polygon with 11 sides or more. In some embodiments, the polygon may be regular.

At block 208, each region of a first subset of the plurality of regions may be determined to be ascribed to the tumor, where the bounding area for each region of the first subset is fully within the tumor area. The bounding area may be determined to be fully within the tumor area when a subset of points of the polygon or ellipse are determined to be within the tumor area. For example, in a 2D coordinate system, points representing the extremes along the two axes may be compared to the tumor area. As examples, the topmost, bottommost, leftmost, and/or rightmost points may be determined to be in the tumor area. In some embodiments, the vertices of the polygon may be determined to be in the tumor area.

In some embodiments, the first subset of the plurality of regions may also be determined to be outside an excluded region. The excluded region may include a biological structure (e.g., tumor, peritumor, stroma, necrosis, red blood cells, staining artifact, or tissue fold). The determination of the region being outside the excluded region would be similar to the determination of a region being within the tumor area. The bounding area may be determined to be outside the excluded region when vertices or extremum points are determined to be outside the excluded region.

At block 210, the bounding area for each region of a second subset of the plurality of regions may be determined to be partly within the tumor area. The bounding area may be determined to be partly within the tumor area when each of at least one of the points representing extremes, but less than all of the points representing extremes, is determined to be outside the tumor area. In some embodiments, one or more vertices of the bounding polygon (but not all vertices) may be determined to be outside the tumor area.

In some embodiments, the bounding area for each region of a third subset of the plurality of regions may be determined to be wholly outside the tumor area. The bounding area may be determined to be wholly outside the tumor area when all points representing the extremes or all vertices of the bounding polygon are determined to be outside the tumor area.

At block 212, whether to ascribe the region to the tumor may be determined for each region of the second subset of the plurality of regions. The determination is based on an intersection/exclusion of the region and the tumor region. In some embodiments, the intersection is calculated as the area of the region overlapping with the tumor area. A new sub-region, representing only the parts of the region within the tumor area, may be used for analysis.

In other embodiments, the intersection may be characterized by an area or a percentage of the region within the tumor. The intersection may be compared to a threshold value (e.g., a minimum area or minimum percentage). When the intersection exceeds the threshold value, then the region is ascribed to the tumor. If the intersection does not exceed the threshold value, then the region is not ascribed to the tumor. The intersection may be calculated using the geometry of the region and the tumor area.

In some embodiments, a proportion of the region may be ascribed to the tumor based on the intersection percentage. For example, the same percentage as the intersection percentage may be ascribed to the tumor. Any metric determined from the region may be scaled by the intersection percentage.

Two hash tables may be used to track the relationship between polygons/regions and tumor/tissue area. A tumor hash table may be updated with information regarding with a region/polygon is ascribed to the tumor or not. In addition, the tumor hash table may also track the information regarding whether a region is partially/fully inside or outside the tumor area; it may also update a region/polygon to which tumor area (the number index of tumor) belongs. Similarly, a tissue hash table may be updated with information regarding a region/polygon is ascribed to the tissue or not. In addition, whether a region is partially/fully inside or outside the tissue area and the region to which tissue area (the number index of tissue) belongs.

At block 214, a metric characterizing a biological observation may be accessed for each region ascribed to the tumor. The metric may be any metric disclosed herein. For example, the metric may be a count or density of a particular type of cell or phenotype within the region. The count or density of the particular type of cell may be the count or density of the regions within the tumor area or of regions wholly outside the tumor. Characterizing the metric may include referencing the hash tables to determine whether the region is ascribed to the tumor/tissue.

As an example, the metric may include positions of different types of regions. The plurality of regions may include a first region corresponding to a first tissue block or a first biological object. The plurality of regions may further include a second region corresponding to a second tissue block or a second biological object. Each of the first and second regions are determined to be ascribed to the tumor. The metric characterizing the biological observation may identify a position associated with the regions.

In some embodiments, the first tissue block or the first biological object may be a cell of a first phenotype, which may be a single biomarker or the co-localization of different biomarkers. The second tissue block or the second biological object may be a cell of a second phenotype. The metric may include positions of the cells/phenotypes.

In some embodiments, the first region may correspond to a cell of a first phenotype, and the second region may correspond to the second tissue block. The metric may include a position of a cell and a position of a tissue or other region.

The metric may include different features of regions or phenotypes, such as the absolute intensity value, intensity percentage and distribution, shape, area, a compression level, and so on. Each region of the plurality of regions may correspond to a tissue block or a biological object. The compression level may be of the region corresponding to a tissue block or a biological object. The compression level is described as a feature example shown later in the document.

At block 216, a value of a result may be generated based on the accessed metrics. The result may be generated for regions ascribed to the tumor. For example, for when the metric includes a position of a region or cell, the result may identify a distance between a first position identified by the metric for a specific region (e.g., the first region) and a second position identified by the metric for another region (e.g., the second region) or cell. The result may include each of the accessed metrics. In some embodiments, the result may include a statistical value of the accessed metrics. For example, the result may include a mean, median, mode, percentile, or standard deviation of the accessed metrics. The result may include the statistical value when one or more accessed metrics exceed a threshold value.

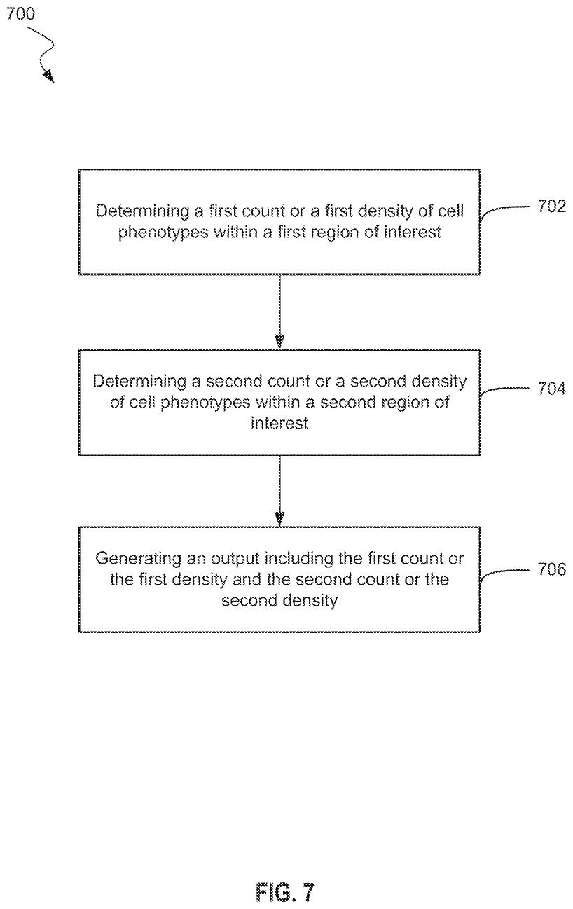

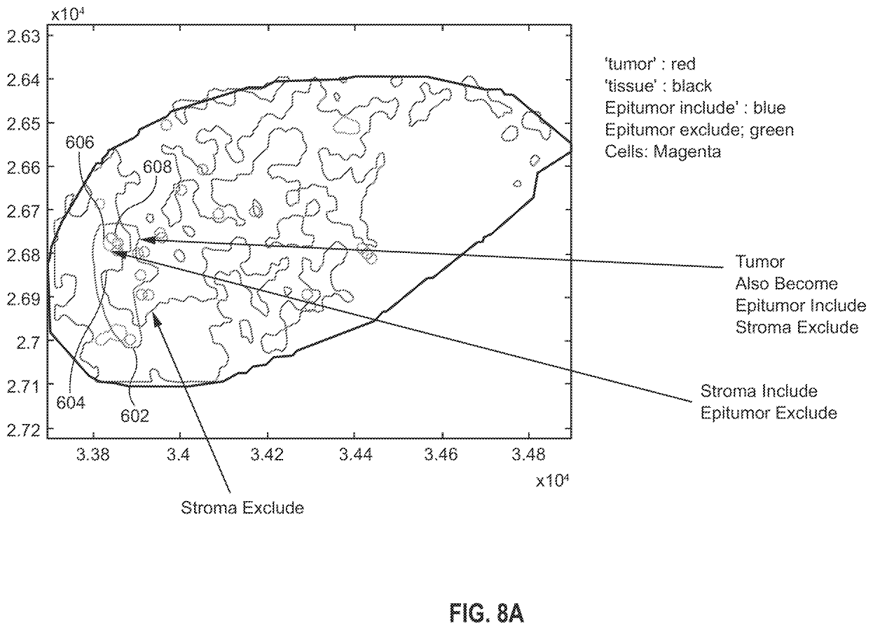

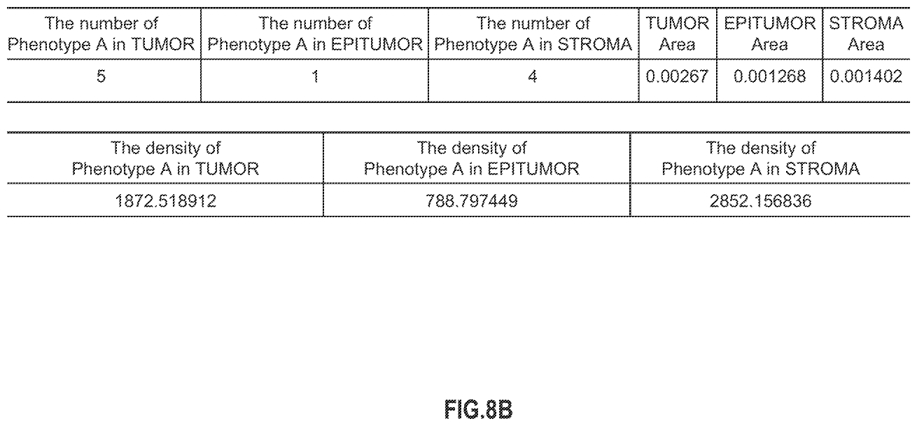

In some embodiments, the count or density of a particular cell in a particular tissue block or biological object may be used as a metric. A subset of the plurality of regions may correspond to a tissue block or a biological object. The method may include accessing, for each region of this subset of the plurality of regions, the metric characterizing the biological observation. Generating the value of the result may include determining a value of a function including the metrics for each region ascribed to the tumor and for each region ascribed to the subset of the plurality of regions. For example, the result may be a ratio of the count or density of a particular type of cell for a tissue block to the count or density of a particular type of cell for the tumor regions. The result may be any of the outputs described with FIGS. 7, 8A, and 8B.

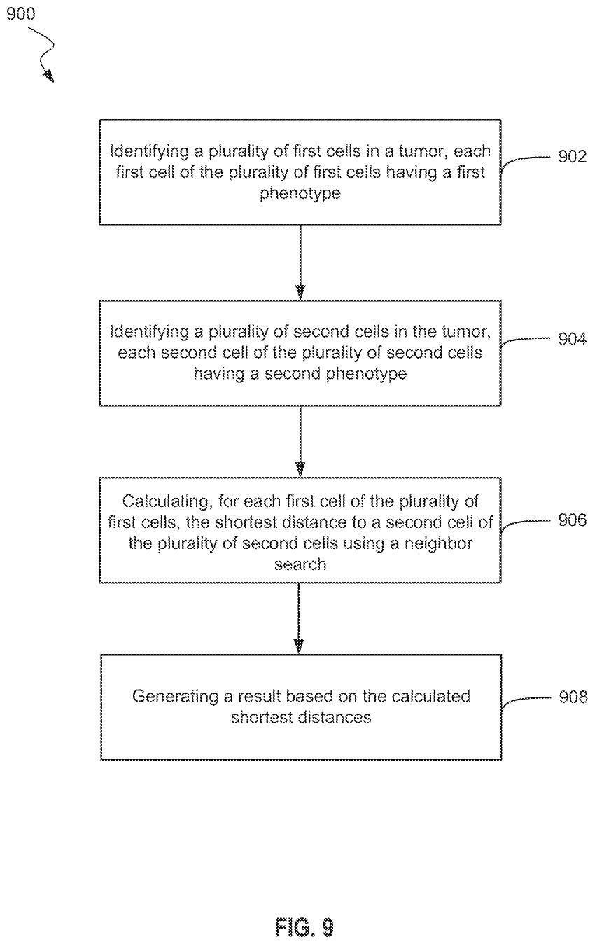

In some embodiments, distances between types of cells may be used to generate the value of the result. The plurality of regions may include a first region with a plurality of first cells having a first phenotype. The plurality of regions may include a second region with a plurality of second cells having a second phenotype. The first regions and the second regions may be determined to be ascribed to the tumor. The metric characterizing the biological observation may identify a position of each cell of a plurality of cells within the region. The result may be generated by calculating, for each first cell of the plurality of first cells, the shortest distance to a second cell of the plurality of second cells using a nearest neighbor search. The nearest neighbor search may be a K-nearest neighbor (KNN) search. A statistical value of the shortest distances may be calculated. The result may include the statistical value. In some embodiments, the count of first cells with the shortest distance from the second cells with a range may be determined. The result may be the count. The range may be predetermined before identifying the tumor area within the image. The result may be a result described with FIGS. 9 to 13.

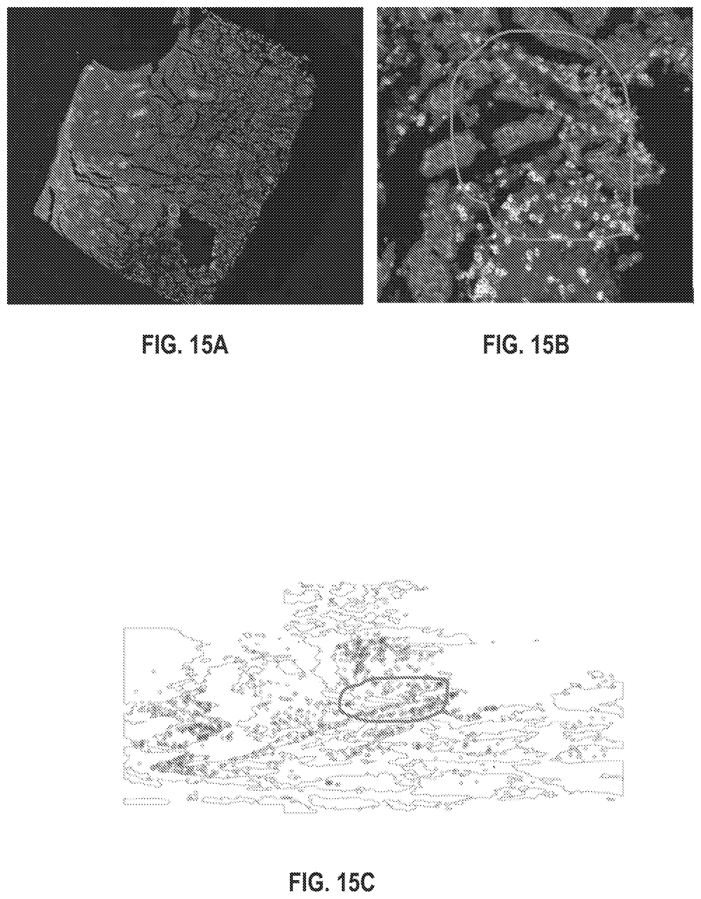

In some embodiments, distances between cells and a tissue block or a biological object may be used to generate the value of the result. The plurality of regions may include a first region with a plurality of first cells having a first phenotype. The plurality of regions may include one or more second regions. Each second region may correspond to a tissue block or a biological object. Each of the first region and the one or more second regions may be determined to be ascribed to the tumor. The metric characterizing the biological observation may identify at least one position of each region. The at least one position may be the position of each cell of the plurality of first cells in the first region. The at least one position may be the position of each second region of the one or more second regions. The position of each second region may be the center of the region or a point on the edge of the second region. The point on the edge of the second region may be the point closest to a first cell. The value of the result may be generated by calculating for each cell of the plurality of first cells, the shortest distance to a second region of the one or more regions using a nearest neighbor search. The nearest neighbor search may be a K-nearest neighbor search. The result may include calculating a statistical value of the shortest distances, and the result may be the statistical value. In some embodiments, the method may include determining a count of first cells with the shortest distance within a range. The range may be predetermined before identifying the tumor area within the image. The result may be the count. The result may be a result described with FIGS. 15A to 19.

The distance between a first cell and a second region may be the closest vertical distance or closest horizontal distance. The KNN search may determine the first cell of the plurality of first cells with the closest vertical distance to the given second region. The method may include calculating the distance between the cell with the closest vertical distance and the given second region. The cell with the closest horizontal distance may also be used.

Results may be reported for each image or each biological sample. In other embodiments, results may be aggregated together for multiple images or multiple biological samples. The aggregation may be reporting the results together or providing a statistical value of the metrics for the multiple images or biological samples. Any result or metric described herein may be used as described above.

At block 218, the value of the result may be compared to a reference value determined by using regions ascribed to another tumor or determined by using regions ascribed to wholly outside the tumor area.

The reference value may be determined by using regions that are wholly outside the tumor area. For example, for each region of a third subset of the plurality of regions, the bounding area may be determined to be wholly outside the tumor area. The metric characterizing the biological observation may be accessed for each region ascribed to wholly outside the tumor. The reference value may be generated based on the accessed metrics for each region ascribed to wholly outside the tumor in the same manner as the value of the result is generated.

A tumor or tumors in one or more reference subjects may be used to determine the reference value. The one or more reference subjects may be known to have a tumor or known to have a certain level of cancer.

At block 220, the result may be determined it is a biomarker for a tumor based on the comparison. The metric may be determined to be a biomarker when the value of the result is statistically different from the reference value, when the reference value is obtained from non-tumor areas. The non-tumor areas may be areas from the same subject or from reference subjects. The reference subjects may be known to not have cancer. In embodiments where the reference value is determined from regions ascribed to tumors, the result may be determined to be a biomarker if the result is not statistically different from the reference value(s).

### B. Methods of Determining Tumor Classifications

Methods may include determining a classification of a tumor. The method may include determining the value of a biomarker in an image with a tumor area. The biomarker may be determined by method 200. The value of the biomarker may be compared to a threshold value. The threshold value may be determined from images of reference subjects having the same tumor classification. The classification of the tumor may be based on the comparison. For example, the tumor may be classified as a more severe category (e.g., malignant or enlarging) when the value of the biomarker exceeds the threshold value. In some embodiments, the tumor classification may be an existence or a severity of cancer. A more severe tumor classification may result in a classification that cancer exists or that cancer is severe. Examples of classifications of cancer include progressive disease and stable disease.

A classification of the tumor corresponding to the tumor area may be determined using the accessed metrics and/or result. The classification may be any number(s) or other characters(s) that are associated with a particular property of the tumor area or other region of interest. For example, a “+” symbol (or the word “positive”) could signify that that the tumor is malignant or enlarging. The classification can be binary (e.g., positive or negative) or have more levels of classification (e.g., a scale from 1 to 10 or 0 to 1). The classification may be that the tumor is benign, stable, or shrinking.

A subject from whom the biological sample was obtained may be treated based on the determined classification. For example, a tumor with a classification of malignant or enlarging may start or increase a tumor treatment (e.g., drugs, radiation, therapy, or surgery). A tumor with a classification of benign or shrinking may end, reduce, or not start a tumor treatment. Classifications in response to a treatment may include complete response, partial response, and no response. For these classifications, the value of the biomarker may be taken before the treatment and at one or more times after the treatment. A change (increase or decrease) in the value of the biomarker may indicate a response to treatment.

Based on one or more biomarkers and optionally other clinical information, a further action may be determined. The further action may include starting or ending treatment of the tumor, enrolling or unenrolling a subject with the tumor in a clinical trial, or performing additional diagnostics tests on the subject. The value of the biomarker may be compared to threshold values. The threshold values may be determined from reference subjects. The reference subjects may include known healthy individuals. In some embodiments, the reference subjects may include individuals with a tumor of a known stage. The threshold value may be a number to establish a statistical difference from the reference subjects. For example, the threshold value may be one, two, or three standard deviations away from values of results determined from healthy reference subjects.

### C. Example Bounding Boxes

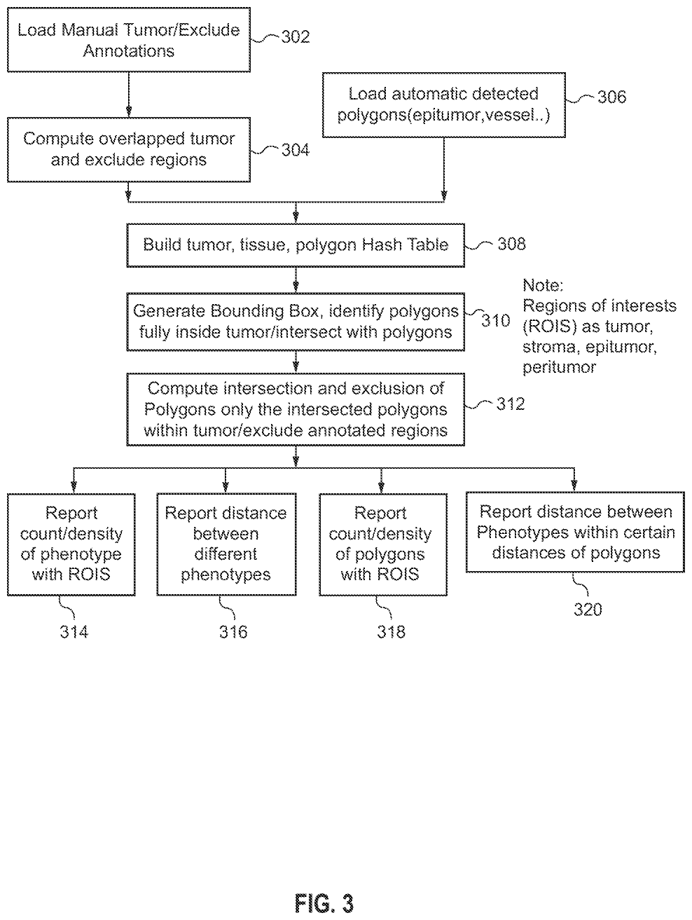

FIG. 3 illustrates an example of an implementation of method 200. At block 302, manual tumor/exclude annotations are loaded. The tumor annotation may be the identified tumor area in block 202. The exclude annotations are to exclude certain regions that are associated with other biological structures. These excludes regions may include folding tissues, artifacts, dysplasia, necrosis, and so on. These excluded regions are ones that may not be used for analysis.

At block 304, overlapped tumor and exclude regions are computed. Pathologists/users may manually generate/draw the tumor or excluded regions, which may include the overlapped tumor or overlapped exclude regions. Before computing any further steps, a sanity check may be performed to avoid the mistakes of overlapped tumor or excluded regions.

At block 306, automatic detected polygons are loaded. These polygons may represent epitumor or vessel (e.g., a vessel in the tissue that provides nutrition for tumor or immune cells). The polygons may be the plurality of regions in method 200.

At block 308, two hash tables are built to track the spatial relationship and information between polygons and tumor or tissues. The tissue is the largest area, with tumor and polygons as subsets of the tissue block.

At block 310, a bounding box may be generated. The bounding box may be the bounding area in block 206 of method 200. Polygons may be identified using the bounding box as fully inside the tumor or intersecting with the tumor, similar to blocks 208 and 210 of method 200.

At block 312, the intersection and exclusion of polygons may be computed. The polygon itself instead of the bounding box may be used to determine an intersection of the polygon with the tumor or with an excluded region. The hash table may be updated for the identification of the polygon as being fully inside, intersecting, or outside the tumor.

At blocks 314, 316, 318, and 320, different results may be reported, including the count/density of phenotypes within the region of interest (e.g., tumor); the distance between different phenotypes; the count/density of polygons, and the distance between phenotypes and polygons. These results may be evaluated as to their use as biomarkers for tumors or cancer, which may include blocks 218 and 220 of method 200.

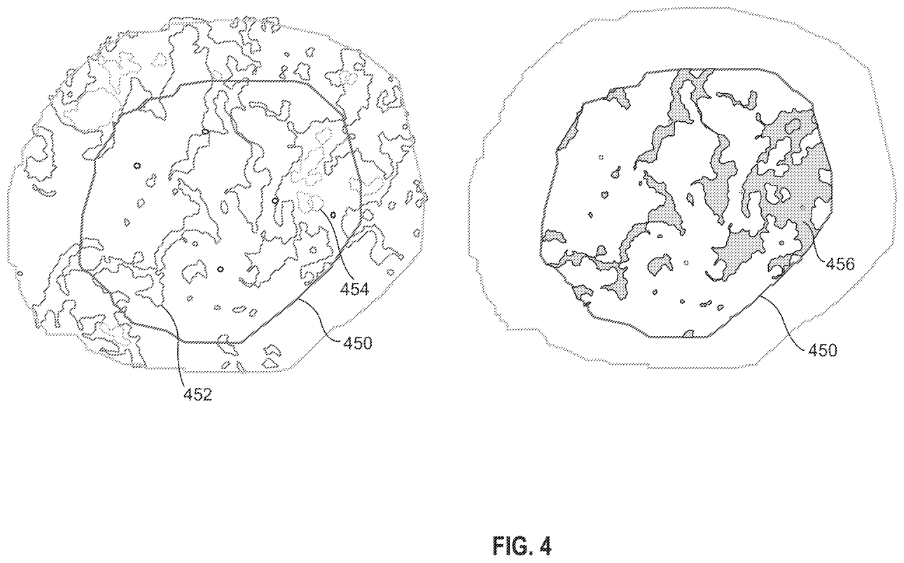

FIG. 4 shows analyzed areas of an image. Red line 450 denotes a tumor area. Blue line 452 denotes one type of polygon. Green lines 454 denotes excluded regions. The polygons to be considered are the polygons within the tumor, but outside the excluded regions. The shaded portion 456 shows the polygons within the tumor and outside the excluded regions. Metrics for shaded portion 456 can be determined as part of the secondary analysis.

### D. Example Biomarker Identification

Cancers may escape immune surveillance and eradication through the up-regulation of the programmed death 1 (PD-1) and its ligand, programmed death-ligand 1 (PD-L1) pathway on tumor cells and in the tumor microenvironment. Blockade of this pathway with antibodies to PD-1 or PD-L1 has led to remarkable clinical responses in some cancer patients.

The number of T cells visible in images of ovarian cancer tissues is analyzed. The T cells studied include CD3, CD8, GZMB, and GZMK. These cells were analyzed in tumor and stroma regions. Cells were determined to be either in the tumor region or in the stoma region (outside the tumor region). Methods used for determining inside or outside of the tumor region include methods described in FIG. 2 (e.g., blocks 202 to 212). In total, 17 ovarian cancer tissues were studied. Of these 17 tissues, nine tissues included tumors infiltrated with immune cells, and eight tissues included tumors that excluded immune cells.

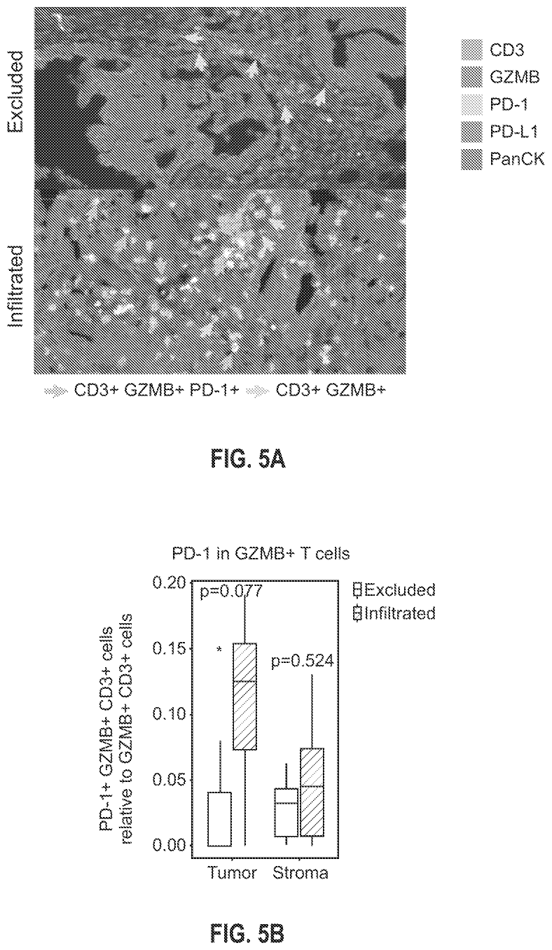

FIG. 5A shows example multiplex fluorescence assay images of tumor tissue. The top image shows a tissue where the tumor tissue excluded immune cells. The top image shows arrows pointing to co-localization of CD3 and GZMB. The bottom image shows a tissue where immune cells have infiltrated the tumor tissue. The bottom image shows arrows pointing to certain cells within the tumor. The green arrows point to co-localization of CD3, GZMB, and PD-1 cells. The yellow arrows point to locations of CD3 and GZMB. FIG. 5A shows that in the excluded tumor, there were no PD-1 cells found while CD3 and GZMB were found. FIG. 5A also shows that in the infiltrated tissue, there were PD-1 cells found, along with CD3 and GZMB.

FIG. 5B graphs the results of the analysis of PD-1 in all 17 tissues. The x-axis shows tumor and stroma tissues, each split among infiltrated and excluded tumor tissues. Cells are allocated to these tumor and stroma regions using methods similar to method 200. The y-axis shows the ratio of PD1, GZMB, and CD3 cells to GZMB and CD3. For tumor regions, the fraction of GZMB+ T cells positive for PD-1 is significantly higher in the infiltrated tumors compared to the excluded tumors for the tumor area (p-value=0.05). For stroma regions, the fraction of GZMB+ T cells positive for PD-1 is marginally higher for infiltrated tumors (p-value=0.3). The results confirm a higher activation state or increased number of GZMB+ T cells in infiltrated tumors. FIG. 5B shows that a biomarker based on the number of PD1, GZMB, CD3 cells relative to GZMB, CD3 cells in the tumor region can be used to identify infiltrated or excluded tumor tissue. Infiltrated tumor tissue may be used to evaluate drug performance. In some embodiments, infiltrated tumor tissue may mean that immune cells are trying to kill the tumor cells and that a drug may be effective. FIG. 5B also shows that the relative number of the cells in stroma to identify infiltrated or excluded tumor tissue would be less effective than using cells in tumor tissue. With reference to method 200 in FIG. 2, the number of cells may be metrics and the result may be the ratio of the number of cells to other cells. The reference value may be the ratio for excluded tumor tissue or the ratio for stroma.

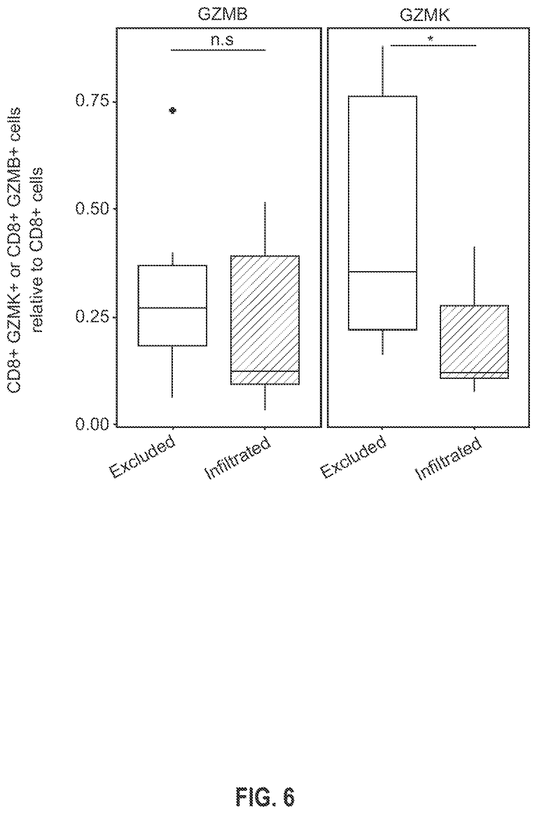

FIG. 6 graphs results of analysis involving GZMB and GZMK in all 17 tissues. The x-axis shows excluded and infiltrated tumor tissues. The y-axis shows the number of CD8 and either GZMK or GZMB cells relative to CD8 cells. The left graph shows GZMB results. The right graph shows GZMK results. The right graph shows that CD8, GZMK cells relative to CD8 cells is higher in excluded samples compared to infiltrated samples. The left graph shows no significant difference between infiltrated and excluded samples for CD8, GZMB cells relative to CD8 cells. The number of CD8, GZMK cells to CD8 cells may be used as a biomarker for infiltrated tumor tissues.

### II. Density or Count of Cell Phenotypes

FIG. 7 shows a method 700 of analyzing an image of a biological sample. The image may be any image described herein.

At block 702, a first count or a first density of cell phenotypes with a first region of interest may be determined. The first region of interest may be a tumor or any region of interest described herein. The cell phenotypes may be determined to be within the first region of interest by any method described herein, including method 200.

At block 704, a second count or a second density of cell phenotypes within a second region of interest may be determined. The second region of interest may be within the first region of interest. The second region of interest may include stroma, epitumor, or peritumor. The cell phenotypes may be determined to be within a second region of interest by any method described herein, including method 200.

A third count or a third density of cell phenotypes within a third region of interest may be determined. The third region of interest may be within the first region of interest. The third region of interest may be stroma, epitumor, or peritumor and may be different from the second region of interest.

At block 706, an output may be generated. The output may include the first count or the first density. The output may further include the second count or the second density. The output may also include the third count or the third density.

Method 700 may further include comparing the second count or the second density to a threshold value. A classification of the first region of interest may be determined based on the comparison. For example, if the second count or second density exceeds the threshold value, then the classification of the first region of interest may be that a disorder is present. For example, the classification may be that a tumor is malignant and growing.

Method 700 may include comparing the first count to a first threshold or comparing the second count to a second threshold. When either the first count exceeds the first threshold or the second count exceeds the second threshold, the output generated may include the first density and/or the second density instead of or in addition to counts.

FIG. 8A illustrates analysis for count or density of different cell phenotypes. Tumor 802 is outlined with a red line. Eptitumor include area (804) is outlined with a blue line and epitumor excluded area (806) is outlined with a green line. The stroma region is also the region excluded from the epitumor region within tumor area. Cells of a certain phenotype (Phenotype A) are shown outlined in magenta (e.g., cell 808).

FIG. 8B shows the results of counting cell phenotypes. FIG. 8B shows that there are five cells with phenotype A in the tumor. Of those five, one is within the epitumor and four are in the stroma. The area of the tumor, epitumor, and stroma are calculated. The areas of epitumor and stroma are areas within the tumor. The density of Phenotype A is then determined by taking the number of cells and dividing by the corresponding area. In some embodiments, the density may be calculated using an area covered by the cells instead of a count of cells.

The results may be used as disclosed with method 200.

### III. Phenotype Distances

FIG. 9 shows a method 900 of analyzing an image of a biological sample. The image may be any image described herein.

At block 902, a plurality of first cells in a tumor may be identified. Each first cell of the plurality of first cells may have a first phenotype. The plurality of first cells may be determined to be in the tumor by any method described herein, including method 200.

At block 904, a plurality of second cells in a tumor may be identified. Each second cell of the plurality of second cells may have a second phenotype. The plurality of second cells may be determined to be in the tumor by any method described herein, including method 200.

At block 906, for each first cell of the plurality of cells, the shortest distance to a second cell of the plurality of second cells may be calculated. The shortest distance is between the first cell and any second cell of the plurality of second cells. The calculation may use a nearest neighbor search, including, as examples, K-nearest neighbor (KNN), k-d trees, vantage point trees, and ball trees. A commonly used distance metric by using the Euclidean distance to compute two sets of plurality of cells/phenotypes will cause a hugely complex computation compared to KNN search and other nearest neighbor searches. The brute force method for distances would take a lot of computation. This method could be used to validate whether the KNN search or other nearest neighbor searches obtain accurate results in a small subset examples.

At block 908, a result based on the calculated shortest distances may be generated. The result may be a list of the shortest distances. In some embodiments, a statistical value (e.g., mean, median, mode, percentile, standard deviation) of the statistical value may be calculated. The result may include the statistical value. The results may be used as disclosed with method 200.

In some embodiments, a count of the first cells with the shortest distance within a certain range may be determined. The result may include the count of first cells. In embodiments, counts of first cells with shortest distances in several different ranges may be determined. The result may include these counts. These counts may be presented as a histogram.

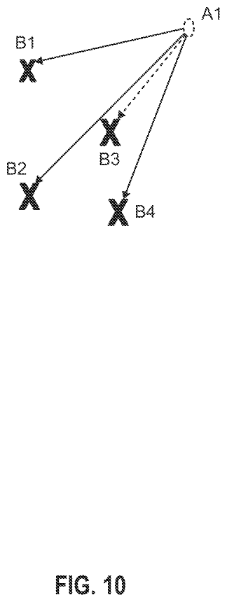

FIG. 10 shows a computation of distance from phenotype A to phenotype B. FIG. 8 shows a single phenotype A, A1. Four phenotypes B are present: B1, B2, B3, and B4. The shortest distance is between A1 and B3 (denoted by the dashed line).

FIG. 11 shows multiple phenotypes A and phenotypes B. Three phenotypes A, denoted as red circles, are within a tumor. Two phenotypes B, denoted as blue Xs, are within the tumor.

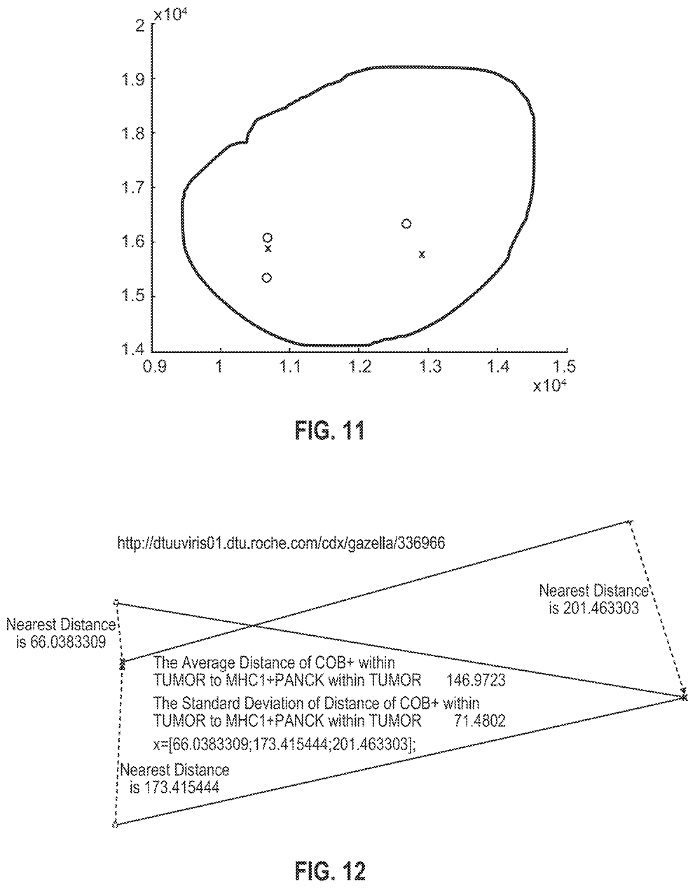

FIG. 12 shows the distances between phenotypes A and phenotypes B. The shortest distances are shown by the dashed lines. The shortest distances are found to be 66.0, 173.4, and 201.4. Statistical values can then be calculated on the distances. For example, the mean average shortest distance is 147.0 and the standard deviation is 71.5.

The arrangement of phenotypes A and phenotypes B may be more complicated than shown in FIG. 11. Calculating every single distance may be computationally intensive and inefficient. A K-nearest neighbor (KNN) search is used to search the closest neighbor between two different phenotypes. A KNN search with the configuration of FIG. 11 resulted in the same distances, mean, and standard deviation as calculating all the distances between the two phenotypes. Compared to brute force methods (e.g., computing Euclidean distance between two sets of plurality of cells/phenotypes), KNN search is more computationally efficient.

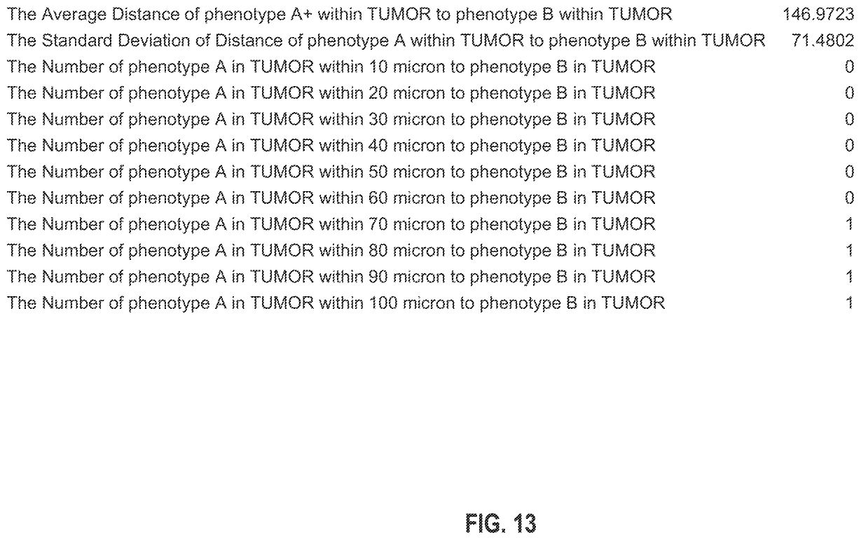

FIG. 13 shows a possible table of results from this analysis. FIG. 13 shows the average and standard deviation of the shortest distances. FIG. 13 also lists the number of phenotype A in the tumor with a certain range of phenotype B. In this example, one phenotype A is 66.0 microns from one phenotype B. This one phenotype A corresponds to the value of 1 for the number of phenotype A with 70 micron, within 80 micron, within 90 micron, and within 100 micron of phenotype B.

### IV. Cells to Regions Distances

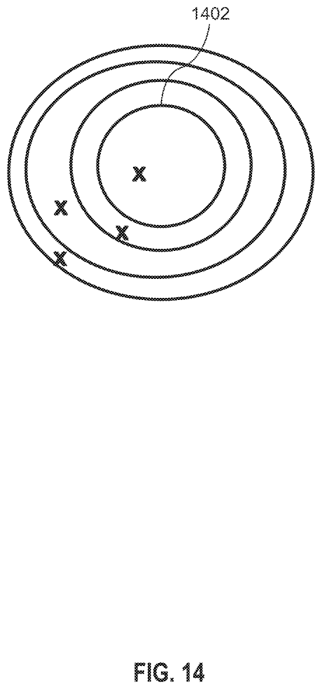

Distances from cells of a phenotype to regions may be useful in clinical analysis. FIG. 14 shows contours of an epitumor and a phenotype represented as blue Xs. Innermost circle 1402 represents the epitumor. The phenotypes have different distances from the epitumor. The phenotype within the epitumor is considered to have a distance of zero. The phenotype distances to the epitumor may be reported on a histogram with different distance distribution ranges to the epitumor.

FIG. 15A shows an image of a biological sample. FIG. 15B shows a zoomed-in image with a red circle annotating the tumor region. FIG. 15C shows an image including blue polygons representing epitumors and black circles representing cells of a phenotype. The red outline represents the tumor area.

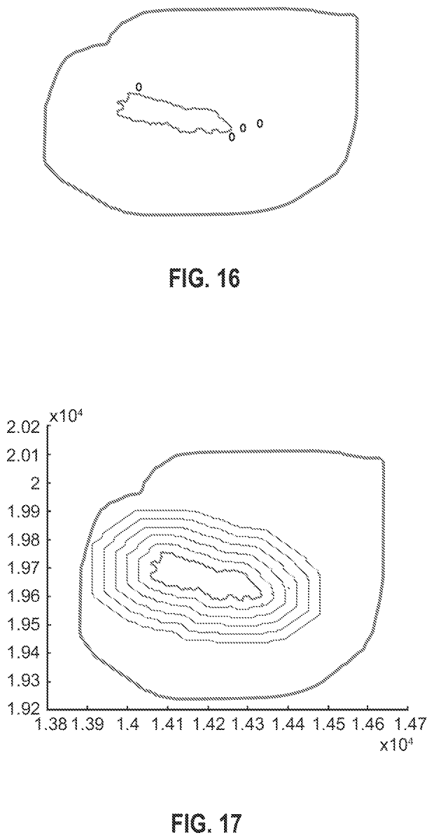

FIG. 16 shows the selection of a single epitumor polygon within a tumor. A few cells of phenotype A are denoted as black circles. Here the epitumor is selected as an example of polygons. (Similarly, vessel and/or fibroblast activation protein stroma could also be selected as the polygons.)

FIG. 17 shows the single epitumor surrounded by five contours. The five contours are simulated based on a distance from the epitumor polygon. The contours are spaced 10, 20, 30, 40, and 50 microns from the epitumor polygon. The cells of a certain phenotype are shown as red dots. FIG. 17 shows from the contours that three cells are within 10 micron of the epitumor. All four cells are within 40 micron of the epitumor.

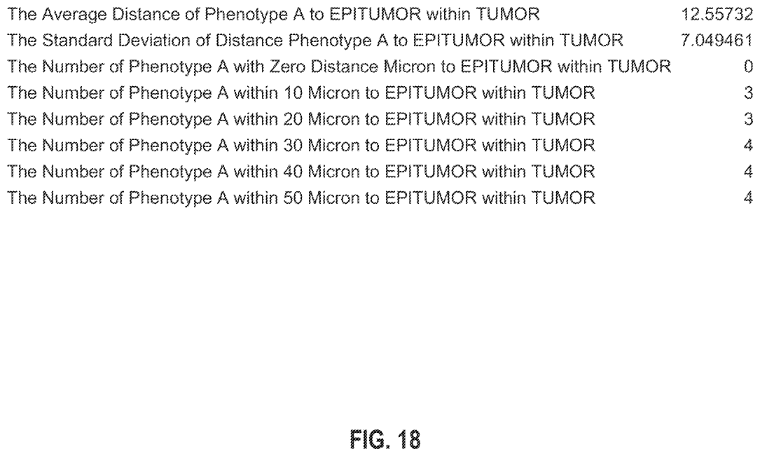

FIG. 18 shows a table with results of the distances from cells of phenotype A to epitumor. The average distance and standard deviation of the distances can be determined after calculating each distance from the cells to the epitumor.

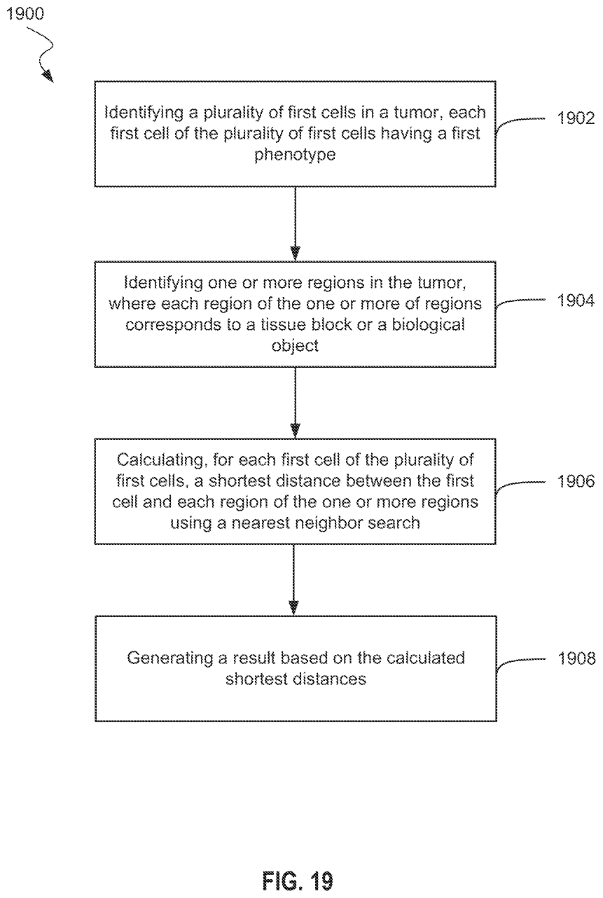

FIG. 19 shows a method 1900 of analyzing an image of a biological sample. The image may be any image described herein.

At block 1902, a plurality of first cells in a tumor may be identified. Each first cell of the plurality of first cells may have a first phenotype. The plurality of first cells may be determined to be in the tumor by any method described herein.

At block 1904, one or more regions in the tumor may be identified. Each region of the one or more regions may correspond to a tissue block or a biological object. The one or more regions may be determined to be in the tumor by any method described herein.

At block 1906, a shortest distance between the first cell and each region of the one or more regions may be calculated using a nearest neighbor search. Examples of nearest neighbor searches include K-nearest neighbor (KNN), k-d trees, vantage point trees, and ball trees The KNN search may determine the cells/phenotypes that have the closest vertical distance to a region. In some embodiments, the distance may be the closest horizontal distance or a distance across another dimension. The distance between the cell/phenotype and the regions can be calculated. The calculated distances may be sorted to analyze the distance distributions from the cells/phenotypes to the regions. Other nearest neighbor searches may be used in a similar manner.

At block 1908, a result may be generated based on the calculated shortest distances. The result may be similar to FIG. 16. The result may include the count of cells/phenotypes in a certain range. The results may be used as disclosed with method 200.

The KNN search generated the results in FIG. 16. The KNN search avoids computation of the surrounding distance contour masks used in simulation research. The KNN search is faster and more efficient in obtaining the same results compared to use of contour masks.

### V. Compression Level

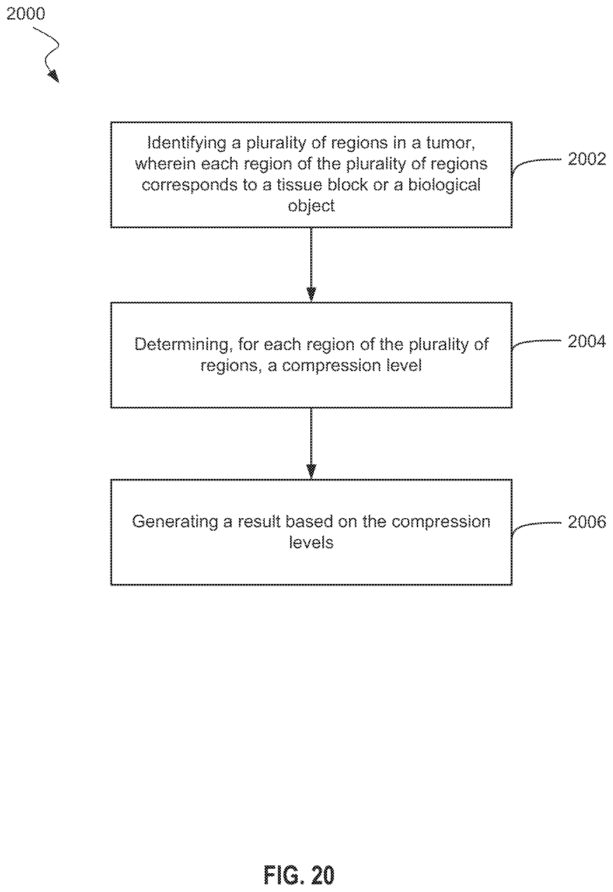

FIG. 20 shows a method 2000 of analyzing an image of a biological sample. The image may be any image disclosed herein.

At block 2002, a plurality of regions in a tumor may be identified. Each region of the plurality of regions may correspond to a tissue block or a biological object. Block 2002 may be similar to block 1304.

At block 2004, a compression level for each region of the plurality of regions may be determined. The compression level may be calculated from a ratio of the area to one or more characteristic dimensions. The characteristic dimension may be a width, length, or length of the major axis of the region, or length of the minor axis of the region. The compression level may also include the degree to which the lumen of the vessel is free of CD31 cells, which are a biomarker for vessel walls.

At block 2006, a result based on the compression levels may be generated. The result may include a list of the compression levels. In some embodiments, the result may include a count of regions in a category of a compression level. The different categories of compression levels may be based on the magnitude of the compression (e.g., low, medium, high). The results may include areas of the regions. The results may further include statistical values of the compression levels and/or areas. The results may be used as disclosed with method 200.

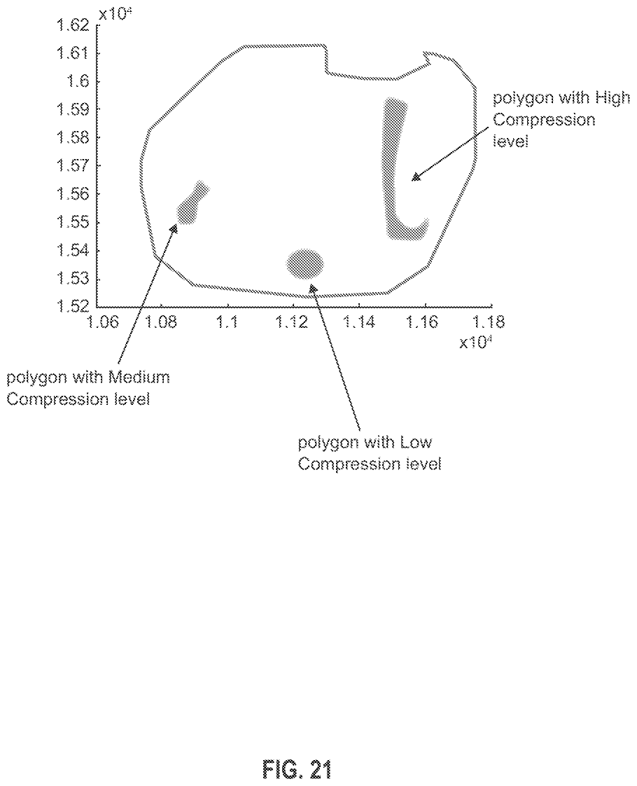

FIG. 21 shows a tumor with regions of different compression levels. The tumor is outlined with a red line. The regions are shown as green-filled polygons. A polygon with a low compression level is circular in shape. A polygon with a high compression level is long and skinny, with a high aspect ratio of height to width. A polygon with a medium compression level is not as long and skinny as the polygon with the high compression level and also not circular like the polygon with the low compression level.

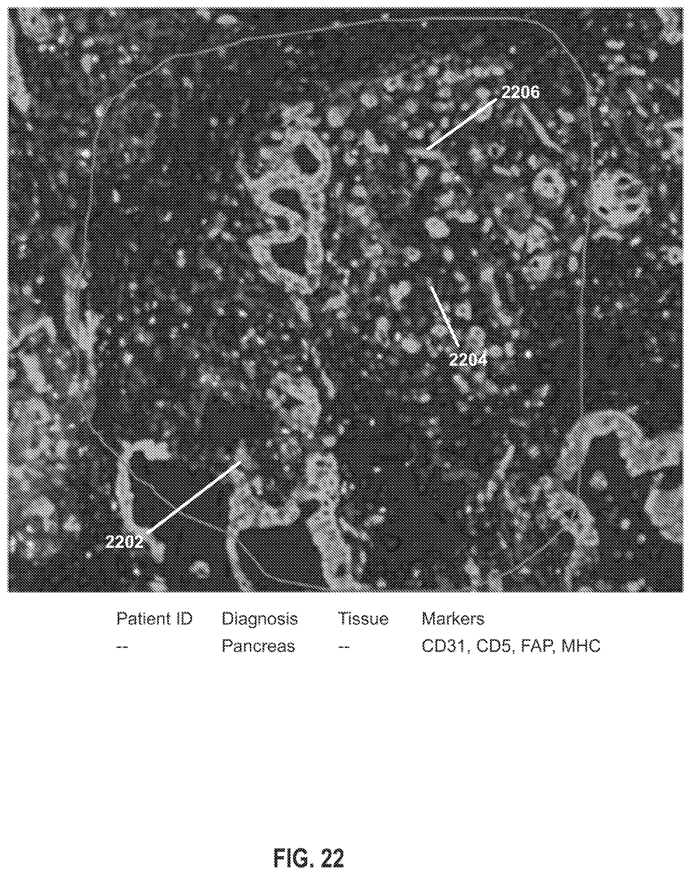

FIG. 22 shows three polygons with low, medium, and high compression levels, each marked with a pink outline. Polygon 2202 has a low compression level. Polygon 2204 has a medium compression level. Polygon 2206 has a high compression level.

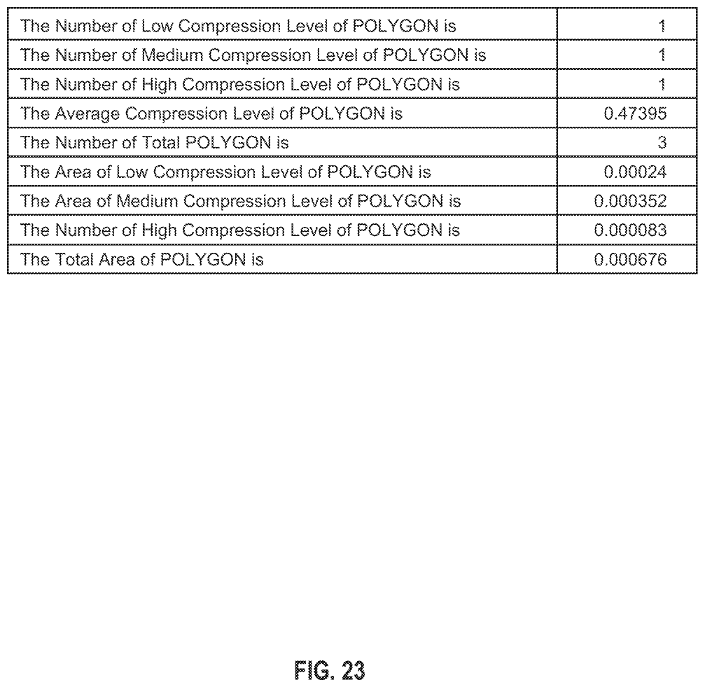

FIG. 23 shows a possible list of results for compression levels. The number of polygons in each of low, medium, and high categories is listed. The average compression level is also listed. The areas of the polygons and the total area of the polygons are also reported.

### VI. Computer System

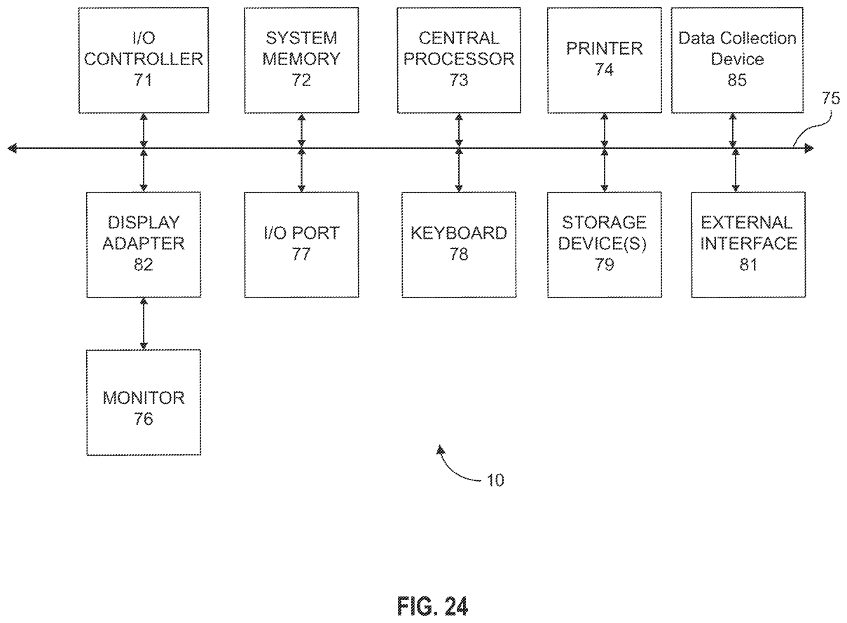

The image analysis methods described above may be performed by a computer system, which may include computer system 10 in FIG. 24. In some embodiments, a computer system includes a single computer apparatus, where the subsystems can be the components of the computer apparatus. In other embodiments, a computer system can include multiple computer apparatuses, each being a subsystem, with internal components. A computer system can include desktop and laptop computers, tablets, mobile phones, other mobile devices, and cloud-based systems.

The subsystems shown in FIG. 24 are interconnected via a system bus 75. Additional subsystems such as a printer 74, keyboard 78, storage device(s) 79, monitor 76 (e.g., a display screen, such as an LCD or LED), which is coupled to display adapter 82, and others are shown. Peripherals and input/output (I/O) devices, which couple to I/O controller 71, can be connected to the computer system by any number of means known in the art such as input/output (I/O) port 77 (e.g., USB). For example, I/O port 77 or external interface 81 (e.g. Ethernet, Wi-Fi, etc.) can be used to connect computer system 10 to a wide area network such as the Internet, a mouse input device, or a scanner. The interconnection via system bus 75 allows the central processor 73 to communicate with each subsystem and to control the execution of a plurality of instructions from system memory 72 or the storage device(s) 79 (e.g., a fixed disk, such as a hard drive, or optical disk), as well as the exchange of information between subsystems. The system memory 72 and/or the storage device(s) 79 may embody a computer readable medium. Another subsystem is a data collection device 85, such as a camera, microscope, microphone, accelerometer, and the like. The IHC data described herein may be acquired by data collection device 85. In some embodiments, the image data may be transferred onto storage device 79 or stored in system memory 72. Any of the data mentioned herein can be output from one component to another component and can be output to the user.

A computer system can include a plurality of the same components or subsystems, e.g., connected together by external interface 81, by an internal interface, or via removable storage devices that can be connected and removed from one component to another component. In some embodiments, computer systems, subsystem, or apparatuses can communicate over a network. In such instances, one computer can be considered a client and another computer a server, where each can be part of a same computer system. A client and a server can each include multiple systems, subsystems, or components.

Aspects of embodiments can be implemented in the form of control logic using hardware circuitry (e.g. an application specific integrated circuit or field programmable gate array) and/or using computer software with a generally programmable processor in a modular or integrated manner. As used herein, a processor can include a single-core processor, multi-core processor on a same integrated chip, or multiple processing units on a single circuit board or networked, as well as dedicated hardware. Based on the disclosure and teachings provided herein, a person of ordinary skill in the art will know and appreciate other ways and/or methods to implement embodiments of the present invention using hardware and a combination of hardware and software.

Any of the software components or functions described in this application may be implemented as software code to be executed by a processor using any suitable computer language such as, for example, Java, C, C++, C#, Objective-C, Swift, or scripting language such as Perl or Python using, for example, conventional or object-oriented techniques. The software code may be stored as a series of instructions or commands on a computer readable medium for storage and/or transmission. A suitable non-transitory computer readable medium can include random access memory (RAM), a read only memory (ROM), a magnetic medium such as a hard-drive or a floppy disk, or an optical medium such as a compact disk (CD) or DVD (digital versatile disk) or Blu-ray disk, flash memory, and the like. The computer readable medium may be any combination of such storage or transmission devices.

Such programs may also be encoded and transmitted using carrier signals adapted for transmission via wired, optical, and/or wireless networks conforming to a variety of protocols, including the Internet. As such, a computer readable medium may be created using a data signal encoded with such programs. Computer readable media encoded with the program code may be packaged with a compatible device or provided separately from other devices (e.g., via Internet download). Any such computer readable medium may reside on or within a single computer product (e.g. a hard drive, a CD, or an entire computer system), and may be present on or within different computer products within a system or network. A computer system may include a monitor, printer, or other suitable display for providing any of the results mentioned herein to a user.

Any of the methods described herein may be totally or partially performed with a computer system including one or more processors, which can be configured to perform the steps. Thus, embodiments can be directed to computer systems configured to perform the steps of any of the methods described herein, potentially with different components performing a respective step or a respective group of steps. Although presented as numbered steps, steps of methods herein can be performed at a same time or at different times or in a different order. Additionally, portions of these steps may be used with portions of other steps from other methods. Also, all or portions of a step may be optional. Additionally, any of the steps of any of the methods can be performed with modules, units, circuits, or other means of a system for performing these steps. These steps may be stored as image analysis code in system memory 72 or on storage device(s) 79.

The specific details of particular embodiments may be combined in any suitable manner without departing from the spirit and scope of embodiments of the invention. However, other embodiments of the invention may be directed to specific embodiments relating to each individual aspect, or specific combinations of these individual aspects.

The above description of example embodiments of the present disclosure has been presented for the purposes of illustration and description. It is not intended to be exhaustive or to limit the disclosure to the precise form described, and many modifications and variations are possible in light of the teaching above.

A recitation of “a”, “an”, or “the” is intended to mean “one or more” unless specifically indicated to the contrary. The use of “or” is intended to mean an “inclusive or,” and not an “exclusive or” unless specifically indicated to the contrary. Reference to a “first” component does not necessarily require that a second component be provided. Moreover, reference to a “first” or a “second” component does not limit the referenced component to a particular location unless expressly stated. The term “based on” is intended to mean “based at least in part on.”

All patents, patent applications, publications, and descriptions mentioned herein are incorporated by reference in their entirety for all purposes. None is admitted to be prior art.

1. A method of identifying a biomarker for a tumor using an image of a biological sample, the method comprising:
identifying a tumor area within the image, the tumor area depicting a boundary of the tumor;
identifying a plurality of regions of the image, wherein each region of the plurality of regions corresponds to a tissue block or a biological object;
defining, for each region of the plurality of regions, a bounding area for the region that encompasses the region, wherein the bounding area includes a polygon or an ellipse;
determining, for each region of a first subset of the plurality of regions, that the region is to be ascribed to the tumor, wherein the bounding area for each region of the first subset is fully within the tumor area;
determining, for each region of a second subset of the plurality of regions, that the bounding area for the region is partly within the tumor area;
determining, for each region of the second subset of the plurality of regions, whether to ascribe the region to the tumor based on an intersection of the region and the tumor area;
accessing, for each region ascribed to the tumor, a metric characterizing a biological observation;
generating a value of a result based on the accessed metrics for the regions ascribed to the tumor;
comparing the value of the result to a reference value determined by using regions ascribed to another tumor or determined by using regions ascribed to wholly outside the tumor area; and
determining whether the result is a biomarker based on the comparison.

2. The method of claim 1, wherein the reference value is determined by:
determining, for each region of a third subset of the plurality of regions, that the bounding area for the region is wholly outside the tumor area,
accessing, for each region ascribed to wholly outside the tumor, the metric characterizing the biological observation, and
generating the reference value based on the accessed metrics for each region ascribed to wholly outside the tumor in the same manner as the value of the result is generated.

3. The method of claim 2, further comprising determining that the metric is the biomarker when the value of the result is statistically different from the reference value.

4. The method of claim 1, wherein:
the metric is a count or density of a particular type of cell within the region.

5. The method of claim 4, wherein the count or density of the particular type of cell is the count or density of the regions within the tumor area or wholly outside the tumor.

6. The method of claim 4, wherein a third subset of the plurality of regions corresponds to a tissue block or a biological object,
the method further comprising accessing, for each region of the third subset of the plurality of regions, the metric characterizing the biological observation,
wherein generating the value of the result comprises determining a value of a function comprising the metrics for each region ascribed to the tumor and for each region ascribed to the third subset of the plurality of regions.

7. The method of claim 1, wherein:
the plurality of regions includes:
a first region corresponding to a first tissue block or a first biological object;
a second region corresponding to a second tissue block or a second biological object, wherein each of the first and second regions are determined to be ascribed to the tumor;
the metric characterizing the biological observation identifies a position associated with the region;
the result identifies a distance between a first position identified by the metric for the first region and a second position identified by the metric for the second region.

8. The method of claim 7, wherein:
the first tissue block or the first biological object is a cell of a first phenotype, and
the second tissue block or the second biological object is a cell of a second phenotype.

9. The method of claim 7, wherein:
the first region corresponds to a cell of a first phenotype, and
the second region corresponds to the second tissue block.

10. The method of claim 1, wherein:
the plurality of regions includes:
a first region comprising a plurality of first cells having a first phenotype; and
a second region comprising a plurality of second cells having a second phenotype, wherein each of the first and second regions are determined to be ascribed to the tumor;
the metric characterizing the biological observation identifies a position of each cell of a plurality of cells within the region; and
the value of the result is generated by:
calculating, for each first cell of the plurality of first cells, the shortest distance to a second cell of the plurality of second cells using a nearest neighbor search.

11. (canceled)

12. The method of claim 10, further comprising calculating a statistical value of the shortest distances, wherein the value of the result comprises the statistical value.

13. The method of claim 10, further comprising determining a count of first cells with the shortest distance within a range, wherein the value of the result comprises the count.

14. The method of claim 1, wherein:
the plurality of regions includes:
a first region comprising a plurality of first cells having a first phenotype; and
one or more second regions, each second region of the one or more second regions corresponding to a tissue block or a biological object, wherein each of the first region and the one or more second regions are determined to be ascribed to the tumor;
the metric characterizing the biological observation identifies at least one position of each region, the at least one position being the position of each cell of the plurality of first cells in the first region, and the at least one position being the position of each second region of the one or more second regions; and
the value of the result is generated by:
calculating, for each first cell of the plurality of first cells, the shortest distance to a second region of the one or more second regions using a nearest neighbor search.

15. The method of claim 14, wherein the nearest neighbor search is a K-nearest neighbor (KNN) search, and
for a given second region of the one or more second regions, the KNN search determines the first cell of the plurality of first cells with the closest vertical distance to the given second region,
the method further comprising calculating the distance between the cell with the closest vertical distance and the given second region.

16. The method of claim 14, further comprising calculating a statistical value of the shortest distances, wherein the value of the result comprises the statistical value.

17. The method of claim 14, further comprising determining a count of first cells with the shortest distance within a determined range, wherein the value of the result comprises the count.

18. The method of claim 1, wherein the metric is a compression level.

19. The method of claim 18, wherein each region of the plurality of regions corresponds to a tissue block or a biological object.

20. (canceled)

21. The method of claim 1, further comprising:
capturing the image of the biological sample.

22. (canceled)

23. A method of determining a classification of a first tumor, the method comprising:
determining the value of a biomarker in a first image comprising a first tumor area, the biomarker determined by a method comprising:
identifying a second tumor area within a second image, the second tumor area depicting a boundary of a second tumor;
identifying a plurality of regions of the second image, wherein each region of the plurality of regions corresponds to a tissue block or a biological object;
defining, for each region of the plurality of regions, a bounding area for the region that encompasses the region, wherein the bounding area includes a polygon or an ellipse;
determining, for each region of a first subset of the plurality of regions, that the region is to be ascribed to the second tumor, wherein the bounding area for each region of the first subset is fully within the second tumor area;
determining, for each region of a second subset of the plurality of regions, that the bounding area for the region is partly within the second tumor area;
determining, for each region of the second subset of the plurality of regions, whether to ascribe the region to the second tumor based on an intersection of the region and the second tumor area;
accessing, for each region ascribed to the second tumor, a metric characterizing a biological observation;
generating a value of a result based on the accessed metrics for the regions ascribed to the second tumor;
comparing the value of the result to a reference value determined by using regions ascribed to another tumor or determined by using regions ascribed to wholly outside the second tumor area; and
determining whether the result is a biomarker based on the comparison of the value of the result to the reference value;
comparing the value of a biomarker to a threshold value; and
determining the classification of the first tumor based on the comparison of the value of the biomarker to the threshold value.

24-28. (canceled)
